(19) United States
(12) Patent Application Publication
(10) Pub. No.: US 2011/0201405 A1
(43) Pub. Date: Aug. 18, 2011

(54) ENTERTAINMENT MACHINE HAVING A SIGNAL-GENERATING DEVICE COUPLED TO A MOVABLE SYMBOL-BEARING SUPPORT

(75) Inventor: Dov L. Randall, Las Vegas, NV (US)

(73) Assignee: IGT, Reno, NV (US)

(21) Appl. No.: 13/095,474

(22) Filed: Apr. 27, 2011

Related U.S. Application Data
(63) Continuation of application No. 10/511,459, filed on Mar. 7, 2005.

(30) Foreign Application Priority Data
Apr. 13, 2002 (GB) 0208533.0

(51) Int. Cl. A63F 9/24; A63F 13/08

(52) U.S. Cl. 463/20; 463/46

(57) ABSTRACT

An entertainment machine having a display device including a rotatable reel with symbols around its periphery. The symbols are defined digitally on a support, such as a curved LCD strip, by feed of signals from a signal generating device. The support may rotate with the reel. Alternatively the support may be fixed so that the reel rotates but the support is static. In this case, the support extends round part only of the periphery of the reel and the feed of signals is such as to define symbols which move with the rotation of the reel.

### PRIORITY CLAIM

This application is a continuation of, and claims priority to and the benefit of, U.S. patent application Ser. No. 10/511,459, filed on Mar. 7, 2005, which is a §371 national phase application of PCT/GB03/01409, filed on Apr. 1, 2003, which claims priority to GB Application Serial No. 0208533.0, filed on Apr. 13, 2002, the contents of which are hereby incorporated by reference in their entirety.

### BACKGROUND

This invention relates to player-operable entertainment machines, particularly coin-operated amusement with prizes (AWP) machines, such as “fruit” or “poker” machines of the kind having a main display device for displaying a selected combination of symbols at a win zone. As used herein the term coin is intended also to cover tokens, charge or credit cards or any other means of supplying credit or monetary value.

The main display device of a fruit machine may comprise multiple (usually three or four) side-by-side reels which are rotatable about a common horizontal axis within a housing behind a window at the win zone. Each reel has symbols at equally spaced positions (typically 20 positions) around its periphery and the reels can be brought to rest with one symbol on each reel displayed through the window on one or more so called win lines.

If the displayed symbols constitute or include a predetermined winning combination an award may be made available to the player.

In one well known arrangement, the symbols comprise representations of different fruits and also special (e.g. jackpot) symbols, such as the number 7, a picture of a bar or the like. Some of the symbols may be overprinted with, or otherwise accompanied by additional indications, such as indications corresponding to transfer of play to a supplementary feature game or corresponding to some other special feature or bonus.

The nature and frequency of occurrence of the symbols are selected for the reels depending on the particular machine game and requirements with regard to win likelihood, pay-out percentages and the like.

It is well known to use standardized reel mechanisms for different machines and differences in the symbols may be accommodated by using different reel bands in the form of printed plastics bands removably attached around the peripheries of the reels.

It is usual to provide back illumination for the symbols with lamps housed in the reels and accordingly the reel bands may be made from translucent or transparent plastics material.

The use of attached, printed reel bands is generally inconvenient and restrictive. It means that different symbol combinations require printing of different reel bands, and changes cannot readily be implemented to existing operational machines. Also, reliance on printing limits the ability conveniently to incorporate and change special visual effects.

As an alternative to mechanical reels with attached reel bands it is well known to use video-simulated reels. This permits ready set up and subsequent change of symbols and permits easy incorporation of special visual effects, but simulated reels are not always as acceptable to players as mechanical reels.

### SUMMARY OF THE INVENTION

An object of the present invention is to facilitate the provision of different combinations or variations of symbols on mechanical display devices.

According to one aspect of the invention therefore there is provided a display device for displaying symbols in a player-operable entertainment machine comprising at least one movable member having a symbol-bearing support, and a signal-generating device characterized in that the support is a signal-actuable support whereby the symbols are produced on said support by supply of signals thereto from said signal-generating device.

With this arrangement instead of requiring a specially printed reel band it is possible to use a standardized reel and support and then produce the desired symbols by appropriate signal-actuation of the support. Initial set up and possibly also subsequent change of the symbols can thereby be much facilitated and special visual effects can be readily incorporated.

With regard to the support this may be capable of actuation, to produce the symbols, by application of any suitable signals thereto of an electrical, electromagnetic, magnetic or other nature such that the symbols are created in correspondence with characteristics of the signals.

The signals are preferably of the form of electrical charges or currents whereby the symbols are created in correspondence with applied patterns or sequences of the signals.

In a particularly preferred embodiment the support comprises an LCD substrate which creates the symbols in correspondence with applied digital signals. Other devices such as OLED devices can also be used.

The arrangement may be such that the symbols are produced after actuation of the support and are retained without need for further actuation. Alternatively, continuous or continual actuation may be necessary whereby the symbols are only produced and displayed whilst the actuation is maintained.

Thus, as appropriate, the signal-generating device may be operable to produce and maintain actuating signals and/or to produce actuating signals to establish the corresponding symbols at an occasion, such as a power-up occasion. The signal-generating device may then cease operation leaving display of the symbols maintained by virtue of retentive properties of the support alone and/or by supply of power to the support to effect retention.

Alternatively, in the case where the support has retentive properties (alone or in dependence on supply of power) the support may be pre-actuated whereby the signal generating device may be used only at set up.

The signal-generating device may be adapted to operate in a plurality of pre-determined modes corresponding respectively to a plurality of pre-determined different symbol combinations or variations. Alternatively or additionally, provision may be made for adaptation of the signal-generating device at will to produce different symbol combinations or variations as desired, possibly within defined limiting parameters.

Alternatively or additionally, the signal-generating device may operate automatically to change the symbols on any suitable predetermined random or pseudo random basis between or during play as a consequence of game play parameters, selections or events and/or as a consequence of other non-game related parameters.

Where the signal-generating device has different modes or can be adapted at will, switching between the different modes or the entering of data or instructions at will, thereby to change the displayed symbol combination, may be achieved in any suitable manner, e.g. by operating manual controls such as switches, press buttons, a touch screen, or a keyboard, and/or by selection or substitution of all or part of stored data on a data store medium such as a CD-ROM, EPROM or the like.

Implementation of these changes may be made available to any user, or only to an authorized user, or only at a manufacturing stage.

In the case where the signal generating device operates to change the symbols on an automatic basis, this may be under the control of control circuitry of the entertainment machine or otherwise, such as by a remote control device.

The movable member may take any suitable form. In one embodiment, the member is a rotatable member particularly an axially rotatable reel or drum. In the latter case, the support may be in the form of a flexible or pre-shaped strip mounted in a curved path around or alongside all or part of the outer periphery of the reel or drum so as to face radially outwardly.

In a particularly preferred embodiment, the movable member is a rotatable reel of a player-operable coin-operated entertainment machine, especially an amusement with prizes machine or a fruit machine of the kind described above. Thus, the display device of the invention may comprise the main display device of a fruit machine whereby the display device may comprise multiple side-by-side axially rotatable reels each having a respective said signal-actuable support applied thereto.

The invention is not restricted to movable members in the form of rotatable reels. Other kinds of movable members may also be used such as: (a) a rotatable disc with the support on a face of the disc; (b) wheel or roller drives operable to drive a flexible bands, which may be wholly or partially defined by the said signal-actuable support, around a closed path or loop; or (c) the like.

The invention is not restricted to application of the main display device of a fruit machine. For example, it is usual for fruit machines to incorporate one or more auxiliary reels for supplementary features such as feature games, gamble features or the like, and the display device of the invention may also be used for such reels.

Where used in a fruit machine, the aforesaid change of adaptations may be achieved by operation of external player controls, and/or by internal user controls or selections accessible only to authorized personnel, and/or remotely via a communication link from a nearby control device or from a remote central control location or otherwise, and/or in accordance with pre-determined or random or pseudo-random scheduling whereby changes take place on a predetermined, random or pseudo random basis which is time-determined or triggered by any other suitable event and/or in accordance with game play selections, events or features.

If desired, the support may be illuminated in any suitable manner, such as by back-lighting, reflection or as a consequence of actuation of intrinsic light-producing properties of the support.

The symbols may take any suitable form as required. Thus, the symbols may comprise pictorial representations of fruit special jackpot symbols, numbers, currency values, transfer symbols, etc.

The signal-actuable support may be applied to the movable member so as to be movable therewith. Alternatively, the support may be applied to the movable member so that the support is static and the member moves relative to the support. In such embodiment, signal-actuation of the support is arranged to produce a moving symbol display simulating movement of the symbols together, and preferably in synchronism with the movable member. By way of example, the movable member may comprise a reel with the support mounted inwardly of, and exposed through, an openwork or skeletal reel rim. Alternatively, the movable member may comprise a reel with the support mounted outwardly of and exposed alongside a peripheral edge or edges of a reel rim. The support need only be of a size appropriate to the display zone. That is, for a reel rotatable behind a window such as to display say three symbols, the support need only consist of a corresponding arcuate length.

Thus, and in accordance with a second aspect of the invention there is provided a display device for a player-operable entertainment machine. The display device comprises: (a) at least one movable member arranged to bear symbols for display on the machine; and (b) a signal-generating device, characterized by the provision of a signal-actuable support mounted alongside the movable member. The movable member is movable relative to the support. The symbols are arranged to be produced on such support in a sequence moving in correspondence with movement of the movable member by supply of signals to the support from the signal-generating device.

With this arrangement, although movement of the symbols is only simulated, such movement is accompanied by movement of the member whereby a display corresponding closely to a moving symbol-bearing member is attained.

This second aspect of the invention may incorporate any or all of the hereinbefore described features.

Whilst the association of the support with a movable member is preferred, it may also be possible to use a signal-actuable support which is preferably static and not necessarily associated with any movable member. Here, the signal-actuable support is shaped physically to conform to a simulated path of movement. In the case of simulated reel rotation behind a window, the support may comprise a curved section.

Thus and in accordance with a third aspect of the invention, there is provided a display device for a player-operable entertainment machine. The display device comprises a signal-actuable support and a signal-generating device. The support is shaped to conform to a simulated path of movement and the symbols are arranged to be produced on such support in a sequence moving along such path by supply of signals to the support from the signal-generating device.

With this arrangement, although movement of the symbols is only simulated, such movement takes place along a physically shaped path (such as a curved path) and thereby simulates more closely mechanical movement.

This third aspect of the invention may incorporate any or all of the hereinbefore described features.

Additional features and advantages of the present invention are described in, and will be apparent from, the following Detailed Description and the Figures.

### BRIEF DESCRIPTION OF THE FIGURES

The invention will now be described further by way of example only and with reference to the accompanying drawings in which:

FIG. 1 is a diagrammatic perspective view of one form of a fruit machine according to the invention.

FIG. 2 is a diagrammatic block circuit diagram of the machine of FIG. 1.

FIG. 3 is a perspective view of one form of a display device of the machine.

FIG. 4 is a side view in detail of FIG. 3.

FIG. 5 is a view similar to FIG. 4 of an alternative embodiment.

### DETAILED DESCRIPTION OF THE INVENTION

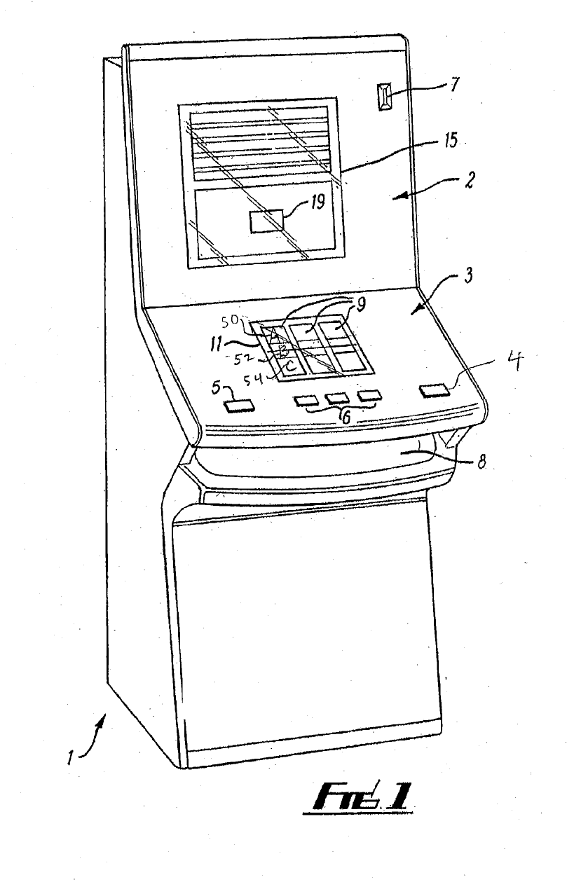

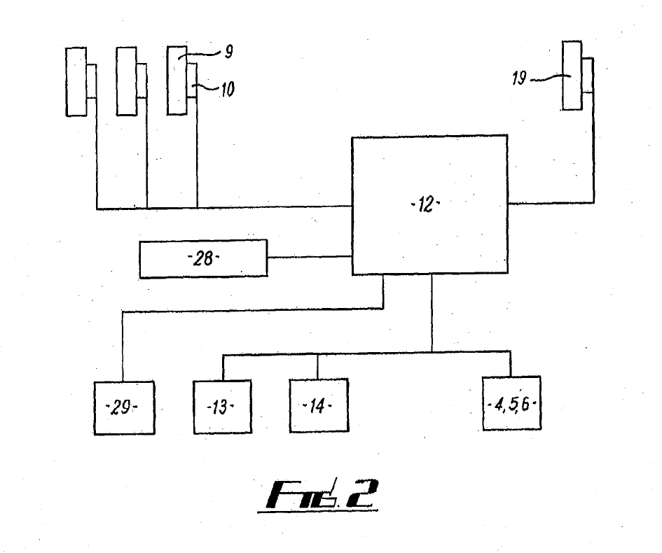

Referring to the drawings, FIG. 1 shows a fruit machine having a floor-standing box shaped housing 1 having a front wall which includes upper and lower glass panels, 2,3, a number of operating buttons 4,5,6, a coin slot 7 and a payout opening 8.

Within the housing 1 there are three axially aligned reels 9 having say 20 symbols at regularly spaced positions around their peripheries. The reels 9 are axially rotatable and are drivably connected to respective stepper motors 10. The reels 9 are arranged behind a window 11 defined by a printed region of the lower glass panel 3. Each reel 9 can be arrested by the respective stepper motor 10 in any of 20 stopping positions in which one symbol is in precise registration with a horizontal win line in the centre of the window 11 and two further symbols are visible above and below the win line.

The stepper motors 10 are connected to a microprocessor-based control unit 12. This unit is also connected to a coin-mechanism 13, a pay-out mechanism 14 and the buttons 4, 5, 6.

In use, the player inserts coins into the coin mechanism 13 through the slot 7 sufficient to generate credit for one or more games, and the machine is actuated so that a game can now be played. The game commences after a start button 4 has been pressed and the reels 9 spin and then come to rest so as to select a combination of symbols displayed on the win line. The displayed symbol combination is assessed by the control unit 12 and a win indication is given in the event that the combination is of a predetermined winning nature.

The control buttons 5 can be used to perform ‘hold’ or ‘nudge’ functions, when made available to the player, so that the player can seek to influence the outcome of a game, in conventional manner.

The upper panel 2 is a transparent glass panel and within this there is a printed display region 15, which can be back-illuminated with a bank of lamps, and which provides a supplementary feature game.

This feature game may comprise a wraparound trail, and a rotatable auxiliary feature reel 19 is visible through a window in the panel 2.

Play transfers to the feature game in the usual way on a random or predetermined basis, such as when predetermined transfer symbols on the main reels 9 are selected on the win line or otherwise.

As shown in FIG. 3, each of the reels 9 and 19 comprises a drum-shaped plastics skeletal framework 20 having two circular rims 21 linked by transverse ribs 22 at spaced intervals around the rims and radial arms 23 extending inwardly from one of the rims to a central hub 24.

The hub 24 is connected to a stepper motor 10 mounted on a support foot 25.

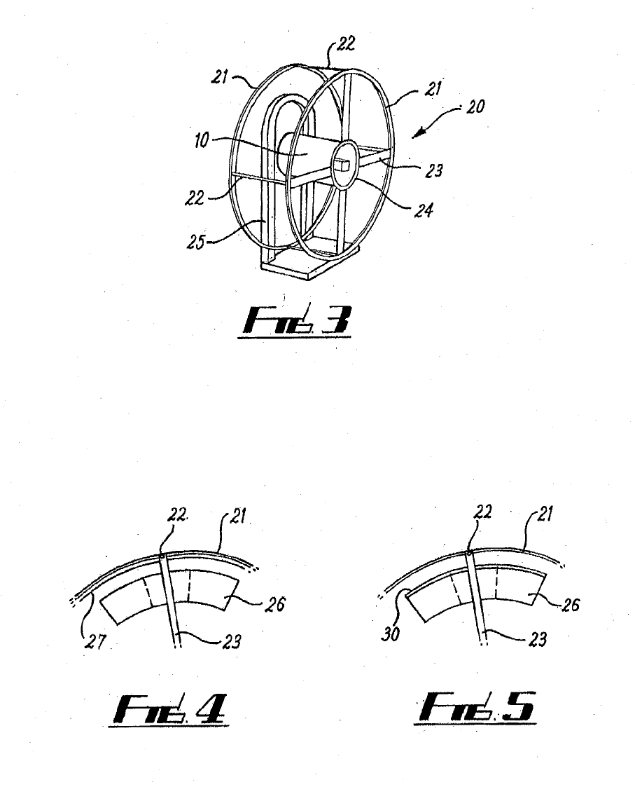

This foot also carries an arcuate light box 26 (shown in FIG. 4 but omitted from FIG. 3) with three, successive sections containing lamps. The light box 26 is disposed between the rims 21 slightly inwardly of the ribs 22.

The reel structure 20 so far described is conventional and would normally be completed by a translucent plastics reel bank fixed between the rim 21 around the entire periphery of the reel on top of the ribs 22. This reel band is conventionally printed with symbols, such as pictures of fruits, etc., at say twenty equally spaced positions. Symbols on the band can be selectively back-illuminated with the light box 26 in the window 11.

In accordance with the described embodiment of the present invention, the reel band is replaced by a similarly sized flexible LCD strip 27.

The strip 27 has edge connectors and is linked by a commutator or other linking arrangement (not shown) to a signal generating device 28 connected to the control unit 12.

The signal generating device 28 is operated to generate patterns or sequences of digital signals which cause symbols 50 to be produced in color at twenty equally spaced positions around the LCD band 27. The band 27 is translucent whereby the symbols 50 are backlit by the light box 26.

The signals may be predetermined, in accordance with data contained in a data storage device 29 connected to the control unit 12 to produce a predetermined sequence of symbols of predetermined kinds.

The machine can therefore be readily set up to provide a desired symbol sequence using a wholly standardized reel mechanism by appropriate selection of stored data.

The arrangement may be such that the utilized data, and hence the substitution of a different data store 29 (e.g. EPROM or the like) and/or by switching between different resident data stores, or different sections of a single such resident data store. This changing may be achieved during a machine set up procedure by authorized personnel who have access to the interior of the machine and/or to protected control devices such as switches, remote connections or the like. Thus, it may be possible to change the symbol sequence from a remote control station via on-line, Internet or other remote link.

Alternatively or additionally, there may be provision for changes to be made by a player. Thus by use of machine controls 4, 5, 6 the player may be able to change games or game play options by selection from available ranges and this may automatically change, in corresponding manner, the symbol sequences e.g. to change the nature of the symbols 50-54 or the frequency of individual symbols 50-54 or the like.

Alternatively or additionally, changes may take place automatically in correspondence with events. Thus, symbols 50-54 may change on a random, pseudo random or predetermined basis with parameters such as elapse of time, number of plays, periods of inactivity, or during play to enhance playing of a game by increasing variety or to reward a successful outcome of a game play feature, or otherwise.

These automatic changes may be of a substantive nature i.e. such as to effect or correspond to a changed game play feature, or of an entertaining nature e.g. to give an interesting visual effect or the like.

With the embodiment of FIG. 5, instead of using a movable LCD strip 27, a short strip 30 is fixed over the light box 26 within the periphery of the reel 20 so as to follow a curved path of similar diameter to that of the drum periphery, and signals are fed to the LCD strip to simulate movement of symbols through a predetermined sequence in correspondence with rotation of the drum structure 20.

Thus, when the drum structure 20 is static, three symbols 50-54 are defined on the strip 30 and displayed statically through the window 11 to the player.

When the drum structure 20 rotates the displayed symbols change in simulation of rotation at the same rate as the drum structure. The player thereby sees the real rotation of the drum structure and the simulated movement of the symbols along the curved path of the strip 30. This represents very closely the appearance of a wholly mechanical reel.

If desired there may be an additional transparent or translucent band around the reel through which the symbols can be seen.

The symbol sequence may be changed as described above in relation to the first embodiment.

With the embodiments described above, symbols 50-54 can be installed and changed in a particularly convenient and flexible manner without departing unduly from the desirable mechanical reel appearance.

It is of course to be understood that the invention is not intended to be restricted to the details of the above embodiment which are described by way of example only.

The invention is claimed as follows:

1. A gaming device comprising:
a housing;
a first frame supported by the housing;
a first illumination device supported by the first frame, the first illumination device being stationary relative to the first frame;
a first rotatable member supported by the first frame;
a first organic light-emitting diode symbol display device supported by the first rotatable member, the first organic light-emitting diode symbol display device including a plurality of different symbol positions;
an input device supported by the housing;
a processor; and
a memory device which stores a plurality of instructions which, when executed by the processor, cause the processor to operate with the input device, the stationary first illumination device, the first rotatable member, and the first organic light-emitting diode symbol display device, for a play of a wagering game, to:
(a) receive a wager from a player for said play of the wagering game, the wagering game including a first plurality of different symbols,
(b) cause the first organic light-emitting diode symbol display device to display a plurality of the first plurality of different symbols for said play of the wagering game, wherein each of the symbols displayed by the first organic light-emitting diode symbol display device is displayed at a different one of the different symbol positions of the first organic light-emitting diode symbol display device,
(c) start rotating the first rotatable member and the first organic light-emitting diode symbol display device relative to the stationary first illumination device,
(d) while rotating the first rotatable member and the first organic light-emitting diode symbol display device, continue to cause the first organic light-emitting diode symbol display device to display the symbols displayed by the first organic light-emitting diode symbol display device,
(e) stop rotating the first rotatable member and the first organic light-emitting diode symbol display device to indicate certain of the symbols displayed by the first organic light-emitting diode symbol display device,
(f) cause the stationary first illumination device to illuminate the indicated symbols of the first organic light-emitting diode symbol display device,
(g) determine whether to provide an award to the player, the determination based, at least in part, on the illuminated indicated symbols of the first organic light-emitting diode symbol display device, and
(h) if the determination is to provide an award, provide said award to the player.

2. The gaming device of claim 1, wherein the plurality of instructions, when executed by the processor, cause the processor to:
(a) start moving the symbols displayed by the first organic light-emitting diode symbol display device relative to the different symbol positions of the first organic light-emitting diode symbol display device, wherein the movement of the symbols displayed by the first organic light-emitting diode symbol display device is in addition to the rotation of the first rotatable member and the first organic light-emitting diode symbol display device, and
(b) stop moving the symbols displayed by the first organic light-emitting diode symbol display device relative to the different symbol positions of the first organic light-emitting diode symbol display device to indicate certain of the symbols displayed by the first organic light-emitting diode symbol display device.

3. The gaming device of claim 2, wherein the plurality of instructions, when executed by the processor, cause the processor to start the movement of the symbols displayed by the first organic light-emitting diode symbol display device relative to the different symbol positions of the first organic light-emitting diode symbol display device while the first rotatable member and the first organic light-emitting diode symbol display device are rotating.

4. The gaming device of claim 2, wherein the plurality of instructions, when executed by the processor, cause the processor to simultaneously start: (a) the rotation of the first rotatable member and the first organic light-emitting diode symbol display device, and (b) the movement of the symbols displayed by the first organic light-emitting diode symbol display device relative to the different symbol positions of the first organic light-emitting diode symbol display device.

5. The gaming device of claim 2, wherein the plurality of instructions, when executed by the processor, cause the processor to simultaneously stop: (a) the rotation of the first rotatable member and the first organic light-emitting diode symbol display device, and (b) the movement of the symbols displayed by the first organic light-emitting diode symbol display device relative to the different symbol positions of the first organic light-emitting diode symbol display device.

6. The gaming device of claim 2, wherein the plurality of instructions, when executed by the processor, cause the processor to: (a) cause the first rotatable member and the first organic light-emitting diode symbol display device to rotate at a first rate, and (b) cause the symbols displayed by the first organic light-emitting diode symbol display device to move relative to the different symbol positions of the first organic light-emitting diode symbol display device at a second rate, wherein the first and second rates are substantially equal.

7. The gaming device of claim 2, which includes:
a second frame supported by the housing;
a second illumination device supported by the second frame, the second illumination device being stationary relative to the second frame;
a second rotatable member supported by the second frame; and
a second organic light-emitting diode symbol display device supported by the second rotatable member, the second organic light-emitting diode symbol display device including a plurality of different symbol positions,
wherein the plurality of instructions, when executed by the processor, cause the processor to operate with the stationary second illumination device, the second rotatable member, and the second organic light-emitting diode symbol display device, for the play of the wagering game, to:
(a) cause the second organic light-emitting diode symbol display device to display a plurality of the first plurality of different symbols for the play of the wagering game, wherein each of the symbols displayed by the second organic light-emitting diode symbol display device is displayed at a different one of the different symbol positions of the second organic light-emitting diode symbol display device,
(b) start rotating the second rotatable member and the second organic light-emitting diode symbol display device relative to the stationary second illumination device,
(c) while rotating the second rotatable member and the second organic light-emitting diode symbol display device, continue to cause the second organic light-emitting diode symbol display device to display the symbols displayed by the second organic light-emitting diode symbol display device,
(d) stop rotating the second rotatable member and the second organic light-emitting diode symbol display device to indicate certain of the symbols displayed by the second organic light-emitting diode symbol display device,
(e) cause the stationary second illumination device to illuminate the indicated symbols of the second organic light-emitting diode symbol display device,
(f) determine whether to provide an award to the player, the determination based, at least in part, on the illuminated indicated symbols of the second organic light-emitting diode symbol display device, and
(g) if the determination is to provide an award, provide said award to the player.

8. The gaming device of claim 7, wherein the plurality of instructions, when executed by the processor, cause the processor to:
(a) start moving the symbols displayed by the second organic light-emitting diode symbol display device relative to the different symbol positions of the second organic light-emitting diode symbol display device, wherein the movement of the symbols displayed by the second organic light-emitting diode symbol display device is in addition to the rotation of the second rotatable member and the second organic light-emitting diode symbol display device, and
(b) stop moving the symbols displayed by the second organic light-emitting diode symbol display device relative to the different symbol positions of the second organic light-emitting diode symbol display device to indicate certain of the symbols displayed by the second organic light-emitting diode symbol display device.

9. The gaming device of claim 8, wherein the plurality of instructions, when executed by the processor, cause the processor to start the movement of the symbols displayed by the second organic light-emitting diode symbol display device relative to the different symbol positions of the second organic light-emitting diode symbol display device while the second rotatable member and the second organic light-emitting diode symbol display device are rotating.

10. The gaming device of claim 8, wherein the plurality of instructions, when executed by the processor, cause the processor to simultaneously start:
(i) the rotation of the first rotatable member,
(ii) the movement of the symbols displayed by the first organic light-emitting diode symbol display device relative to the different symbol positions of the first organic light-emitting diode symbol display device,
(iii) the rotation of the second rotatable member, and
(iv) the movement of the symbols displayed by the second organic light-emitting diode symbol display device relative to the different symbol positions of the second organic light-emitting diode symbol display device.

11. The gaming device of claim 7, wherein the plurality of symbols displayed by the first organic light-emitting diode symbol display device is different than the plurality of symbols displayed by the second organic light-emitting diode symbol display device.

12. The gaming device of claim 1, wherein the plurality of instructions, when executed by the processor, cause the processor to operate with the input device, the stationary first illumination device, the first rotatable member, and the first organic light-emitting diode symbol display device, for a play of an additional wagering game, to:
(a) receive an additional wager from the player for the play of the additional wagering game, the additional wagering game being different than the wagering game and including a second plurality of different symbols,
(b) cause the first organic light-emitting diode symbol display device to display a plurality of the second plurality of different symbols for the play of the additional wagering game, wherein each of the symbols displayed by the first organic light-emitting diode symbol display device is displayed at a different one df the different symbol positions of the first organic light-emitting diode symbol display device,
(c) start rotating the first rotatable member and the first organic light-emitting diode symbol display device relative to the stationary first illumination device,
(d) while rotating the first rotatable member and the first organic light-emitting diode symbol display device, continue to cause the first organic light-emitting diode symbol display device to display the symbols displayed by the first organic light-emitting diode symbol display device,
(e) stop rotating the first rotatable member and the first organic light-emitting diode symbol display device to indicate certain of the symbols displayed by the first organic light-emitting diode symbol display device,
(f) cause the stationary first illumination device to illuminate the indicated symbols of the first organic light-emitting diode symbol display device,
(g) determine whether to provide an award to the player, the determination based, at least in part, on the illuminated indicated symbols of the first organic light-emitting diode symbol display device, and
(h) if the determination is to provide an award, provide said award to the player.

13. The gaming device of claim 12, wherein the plurality of instructions, when executed by the processor, cause the processor, for the play of the additional wagering game, to:
(a) while the first rotatable member and the first organic light-emitting diode symbol display device are rotating, start moving the symbols displayed by the first organic light-emitting diode symbol display device relative to the different symbol positions of the first organic light-emitting diode symbol display device, wherein the movement of the symbols displayed by the first organic light-emitting diode symbol display device is in addition to the rotation of the first rotatable member and the first organic light-emitting diode symbol display device, and
(b) stop moving the symbols displayed by the first organic light-emitting diode symbol display device relative to the different symbol positions of the first organic light-emitting diode symbol display device to indicate certain of the symbols displayed by the first organic light-emitting diode symbol display device.

14. The gaming device of claim 12, wherein the second plurality of different symbols is different than the first plurality of different symbols.

15. The gaming device of claim 1, wherein the first rotatable member includes a reel having a surface configured to support the first organic light-emitting diode symbol display device.

16. The gaming device of claim 1, wherein the first rotatable member includes a wheel having a face configured to support the first organic light-emitting diode symbol display device.

17. The gaming device of claim 1, wherein the first rotatable member is configured to rotate about either: (a) a horizontal axis, or (b) a vertical axis.

18. The gaming device of claim 1, wherein the plurality of instructions, when executed by the processor, cause the processor to, after an occurrence of a designated triggering event in association with the play of the wagering game, cause the first organic light-emitting diode symbol display device to display a plurality of a second plurality of different symbols in association with the play of the wagering game, the second plurality of different symbols being different than the first plurality of different symbols.

19. A gaming device comprising:
a housing;
a first frame supported by the housing;
a first illumination device supported by the first frame, the first illumination device being stationary relative to the first frame;
a first rotatable member supported by the first frame;
a first organic light-emitting diode symbol display device supported by the first frame, the first organic light-emitting diode symbol display device including a first curved display surface, the first curved display surface defining a plurality of different symbol positions, the first organic light-emitting diode symbol display device being stationary relative to the first frame and positioned between the first rotatable member and the first illumination device, the first rotatable member being configured to rotate independently of the first organic light-emitting diode symbol display device;
an input device supported by the housing;
a processor; and
a memory device which stores a plurality of instructions, which when executed by the processor, cause the processor to operate with the input device, the stationary first illumination device, the first rotatable member, and the first organic light-emitting diode symbol display device, for a play of a wagering game, to:
(a) receive a wager from a player for said play of the wagering game, the wagering game including a first plurality of different symbols,
(b) cause the first organic light-emitting diode symbol display device to display a plurality of the first plurality of different symbols for said play of the wagering game, wherein each of the symbols displayed by the first organic light-emitting diode symbol display device is displayed at a different one of the different symbol positions of the first organic light-emitting diode symbol display device,
(c) start rotating the first rotatable member relative to the stationary first illumination device and the first organic light-emitting diode symbol display device,
(d) while rotating the first rotatable member, continue to cause the first organic light-emitting diode symbol display device to display the symbols displayed by the first organic light-emitting diode symbol display device,
(e) stop rotating the first rotatable member,
(f) after stopping the rotation of the first rotatable member, indicate certain of the symbols displayed by the first organic light-emitting diode symbol display device,
(g) cause the stationary first illumination device to illuminate the indicated symbols of the first organic light-emitting diode symbol display device,
(h) determine whether to provide an award to the player, the determination based, at least in part, on the illuminated indicated symbols of the first organic light-emitting diode symbol display device, and
(i) if the determination is to provide an award, provide said award to the player.

20. The gaming device of claim 19, wherein the plurality of instructions, when executed by the processor, cause the processor to:
(a) start moving the symbols displayed by the first organic light-emitting diode symbol display device relative to the different symbol positions of the first organic light-emitting diode symbol display device, wherein the movement of the symbols displayed by the first organic light-emitting diode symbol display device is in addition to the rotation of the first rotatable member, and
(b) stop moving the symbols displayed by the first organic light-emitting diode symbol display device relative to the different symbol positions of the first organic light-emitting diode symbol display device to indicate certain of the symbols displayed by the first organic light-emitting diode symbol display device.

21. The gaming device of claim 20, wherein the plurality of instructions, when executed by the processor, cause the processor to start the movement of the symbols displayed by the first organic light-emitting diode symbol display device relative to the different symbol positions of the first organic light-emitting diode symbol display device while the first rotatable member is rotating.

22. The gaming device of claim 20, wherein the plurality of instructions, when executed by the processor, cause the processor to simultaneously start: (a) the rotation of the first rotatable member, and (b) the movement of the symbols displayed by the first organic light-emitting diode symbol display device relative to the different symbol positions of the first organic light-emitting diode symbol display device.

23. The gaming device of claim 20, wherein the plurality of instructions, when executed by the processor, cause the processor to simultaneously stop: (a) the rotation of the first rotatable member, and (b) the movement of the symbols displayed by the first organic light-emitting diode symbol display device relative to the different symbol positions of the first organic light-emitting diode symbol display device.

24. The gaming device of claim 20, wherein the plurality of instructions, when executed by the processor, cause the processor to: (a) cause the first rotatable member to rotate at a first rate, and (b) cause the symbols displayed by the first organic light-emitting diode symbol display device to move relative to the different symbol positions of the first organic light-emitting diode symbol display device at a second rate, wherein the first and second rates are substantially equal.

25. The gaming device of claim 20, wherein the plurality of instructions, when executed by the processor, cause the processor to operate with the input device, the stationary first illumination device, the first rotatable member, and the first organic light-emitting diode symbol display device, for a play of an additional wagering game, to:
(a) receive an additional wager from the player for the play of the additional wagering game, the additional wagering game being different than the wagering game and including a second plurality of different symbols,
(b) cause the first organic light-emitting diode symbol display device to display a plurality of the second plurality of different symbols for the play of the additional wagering game, wherein each of the symbols displayed by the first organic light-emitting diode symbol display device is displayed at a different one of the different symbol positions of the first organic light-emitting diode symbol display device,
(c) start rotating the first rotatable member relative to the stationary first illumination device and the first organic light-emitting diode symbol display device,
(d) while rotating the first rotatable member, continue to cause the first organic light-emitting diode symbol display device to display the symbols displayed by the first organic light-emitting diode symbol display device,
(e) stop rotating the first rotatable member,
(f) after stopping the rotation of the first rotatable member, indicate certain of the symbols displayed by the first organic light-emitting diode symbol display device,
(g) cause the stationary first illumination device to illuminate the indicated symbols of the first organic light-emitting diode symbol display device,
(h) determine whether to provide an award to the player, the determination based, at least in part, on the illuminated indicated symbols of the first organic light-emitting diode symbol display device, and
(i) if the determination is to provide an award, provide said award to the player.

26. The gaming device of claim 25, wherein the plurality of instructions, when executed by the processor, cause the processor, for the play of the additional wagering game, to:
(a) while the first rotatable member is rotating, start moving the symbols displayed by the first organic light-emitting diode symbol display device relative to the different symbol positions of the first organic light-emitting diode symbol display device, wherein the movement of the symbols displayed by the first organic light-emitting diode symbol display device is in addition to the rotation of the first rotatable member, and
(b) stop moving the symbols displayed by the first organic light-emitting diode symbol display device relative to the different symbol positions of the first organic light-emitting diode symbol display device to indicate certain of the symbols displayed by the first organic light-emitting diode symbol display device.

27. The gaming device of claim 25, wherein the second plurality of different symbols is different than the first plurality of different symbols.

28. The gaming device of claim 20, which includes:
a second frame supported by the housing;
a second illumination device supported by the second frame, the second illumination device being stationary relative to the second frame;
a second rotatable member supported by the second frame; and
a second organic light-emitting diode symbol display device supported by the second frame, the second organic light-emitting diode symbol display device including a second curved display surface, the second curved display surface defining a plurality of different symbol positions, the second organic light-emitting diode symbol display device being stationary relative to the second frame and positioned between the second rotatable member and the second illumination device, the second rotatable member being configured to rotate independently of the second organic light-emitting diode symbol display device,
wherein the plurality of instructions, when executed by the processor, cause the processor to operate with the stationary second illumination device, the second rotatable member, and the second organic light-emitting diode symbol display device, for the play of the wagering game, to:
(a) cause the second organic light-emitting diode symbol display device to display a plurality of the first plurality of different symbols for the play of the wagering game, wherein each of the symbols displayed by the second organic light-emitting diode symbol display device is displayed at a different one of the different symbol positions of the second organic light-emitting diode symbol display device,
(b) start rotating the second rotatable member relative to the stationary second illumination device and the second organic light-emitting diode symbol display device,
(c) while rotating the second rotatable member, continue to cause the second organic light-emitting diode symbol display device to display the symbols displayed by the second organic light-emitting diode symbol display device,
(d) stop rotating the second rotatable member,
(e) after stopping the rotation of the second rotatable member, indicate certain of the symbols displayed by the second organic light-emitting diode symbol display device,
(f) cause the stationary second illumination device to illuminate the indicated symbols of the second organic light-emitting diode symbol display device,
(g) determine whether to provide an award to the player, the determination based, at least in part, on the illuminated indicated symbols of the second organic light-emitting diode symbol display device, and
(h) if the determination is to provide an award, provide said award to the player.

29. The gaming device of claim 28, wherein the plurality of instructions, when executed by the processor, cause the processor to:
(a) start moving the symbols displayed by the second organic light-emitting diode symbol display device relative to the different symbol positions of the second organic light-emitting diode symbol display device, wherein the movement of the symbols displayed by the second organic light-emitting diode symbol display device is in addition to the rotation of the second rotatable member, and
(b) stop moving the symbols displayed by the second organic light-emitting diode symbol display device relative to the different symbol positions of the second organic light-emitting diode symbol display device to indicate certain of the symbols displayed by the second organic light-emitting diode symbol, display device.

30. The gaming device of claim 29, wherein the plurality of instructions, when executed by the processor, cause the processor to start the movement of the symbols displayed by the second organic light-emitting diode symbol display device relative to the different symbol positions of the second organic light-emitting diode symbol display device while the second rotatable member is rotating.

31. The gaming device of claim 29, wherein the plurality of instructions, when executed by the processor, cause the processor to simultaneously start:
(i) the rotation of the first rotatable member,
(ii) the movement of the symbols displayed by the first organic light-emitting diode symbol display device relative to the different symbol positions of the first organic light-emitting diode symbol display device,
(iii) the rotation of the second rotatable member, and
(iv) the movement of the symbols displayed by the second organic light-emitting diode symbol display device relative to the different symbol positions of the second organic light-emitting diode symbol display device.

32. The gaming device of claim 28, wherein the plurality of symbols displayed by the first organic light-emitting diode symbol display device is different than the plurality of symbols displayed by the second organic light-emitting diode symbol display device.

33. The gaming device of claim 19, wherein the first rotatable member includes a reel and a substantially transparent portion coupled to the reel, the reel being positioned relative to the first organic light-emitting diode symbol display device such that at least one of the symbols displayed by the first organic light-emitting diode symbol display device is visible by the player through the substantially transparent portion coupled to the reel.

34. The gaming device of claim 19, wherein the first rotatable member includes a rotatable disc and a substantially transparent portion coupled to the rotatable disc, the rotatable disc being positioned relative to the first organic light-emitting diode symbol display device such that at least one of the symbols displayed by the second organic light-emitting diode symbol display device is visible by the player through the substantially transparent portion coupled to the rotatable disc.

35. The gaming device of claim 19, wherein the first rotatable member is configured to rotate about either: (a) a horizontal axis, or (b) a vertical axis.

36. The gaming device of claim 19, wherein the plurality of instructions, when executed by the processor, cause the processor to, after an occurrence of a designated triggering event in association with the play of the wagering game, cause the first organic light-emitting diode symbol display device to display a plurality of a second plurality different symbols in association with the play of the wagering game, the second plurality of different symbols being different than the first plurality of different symbols.
